(19) United States
(12) Patent Application Publication
(10) Pub. No.: US 2013/0152002 A1
(43) Pub. Date: Jun. 13, 2013

(54) DATA COLLECTION AND ANALYSIS FOR ADAPTIVE USER INTERFACES

(71) Applicants: Yaron Menczel, Mevasseret Zion (IL); Yair Shachar, Ramat Gan (IL)

(72) Inventors: Yaron Menczel, Mevasseret Zion (IL); Yair Shachar, Ramat Gan (IL)

(73) Assignee: MEMPHIS TECHNOLOGIES INC., Dobbs Ferry, NY (US)

(21) Appl. No.: 13/316,510

(22) Filed: Dec. 11, 2011

(51) Int. Cl. G06F 3/01

(52) U.S. Cl. 715/765

(57) ABSTRACT

The present invention provides systems and methods for utilizing sensors of human physical features, ambient conditions, and interfacial behavior for adaptive and friendlier user interfaces for computer applications and communication environments. A user's physical characteristics, for example, age, gender, ergonometric structure and user's interfacial behavior, for example, typing speed, typing error rate and distance from the screen are used to adapt to the user needs and provide more appropriate and fitting interface. In addition, ambient conditions may be considered within the adaptation process.

### BACKGROUND OF THE INVENTION

Designers of user interfaces for various computer applications and communication environments have long been challenged by the need to support diverse and sometimes contradictory user needs and preferences pertaining to those interfaces. Different users with a varied set of characteristics (e.g., age, gender, origin, physical attributes, health conditions, skill level, general attitude, and others) would inherently have different needs and preferences. The designer is often forced into a “one-size-fits-all” compromise.

The common approach to deal with this problem is to provide setup capabilities as part of the user interface, where the user can go over a set of choices and select his preferred attributes for the user interface. While this solution is adequate for some cases, it is often unfriendly, requiring additional attention and knowledge on the part of the user, who may not have the required skill level to perform this setup. It may also be difficult for the user to estimate what could be the optimized set of choices appropriate for his situation.

Another deficiency of the aforementioned common approach is the fact that it is not adaptable to dynamic conditions, for example, changing ambient conditions (e.g., indoor vs. outdoor, noisy vs. quiet environments, etc.). Moreover, the challenges and problems facing the designer of the user interfaces have been complicated by the introduction of a large number of various kinds of platforms, including mobile and 3D-based units.

As an exemplary case to illustrate the problem, we may look at Apple's iPhone Smartphone, which introduced the concept of a pure touch screen for mobile devices. Although touch screens have been around long before, they were used as personal computer (PC) screens and often had an attached mechanical keyboard. The Apple iPhone has been one of the first pure touch screen devices with no mechanical keyboard and a very small size screen (3.5 inch and 640×960 pixels resolution for iPhone 4), which may run a full application using user input.

In order to do that, the designers of Apple software had to assume a certain size for the user's fingers that will allow the separation between display selection elements on the screen (like icons or virtual keyboard characters) in a way that a touch of a finger will accomplish (1) that the user clearly sees where he is pressing and he can press the right location, and (2) that the software can detect what the user pressed without contentions or ambiguity.

Clearly, a compromise had to take place. On the one hand, a designer would like the application to fill as much data in a screen, so that there is no need for zooming or scrolling. On the other hand, the input elements must fit the finger size of most people, which means that for some users the screen display selection elements are too small, and for some others they are too large, and they have to scroll over the screen when there is no real need for it.

In that respect, U.S. Pat. No. 5,627,567 depicts a method to add in certain cases an expanded touch zone for control keys. However, this method only conducts it based on the layout of the control keys, and not on the user characteristics.

U.S. Pat. No. 7,103,852 depicts a method for increasing the size of the viewable and clickable area of a display selection elements in case the user misses the intended display selection element several times above a given threshold number. This method is very limited since it only applies to cases where the application has an a-priory knowledge of what the user intends to click, which is a very limited scenario. The method only increases the area of the tested display selection element, but not the other elements on the screen. The method works in one direction only of increasing the size, but not decreasing it. The method does not adapt to different users, or to changing ambient conditions.

U.S. Pat. No. 7,620,824 depicts a method to change user interface features based on proficiency level regarding a certain feature of an application. However, the method to determine the proficiency level is based on counting the number of times the user used a feature. That patent fails to locate errors on behalf of the user when he is using that feature. More important, that patent does not deal with issues that are not based on proficiency, such as physical characteristics of the user (e.g., his finger footprint). In addition, that patent does not deal with managing the layout of the screen, but instead only deals with the complexity of information that the user will see.

US Patent application 20070271512 depicts a method of personalizing a user interface based on identification of a user or at least characterization of the user such as his age group. The user interface is typically a set of commands that are presentable to the user. This method attempts to perform an identification of the user in order to provide him with a predefined configuration of a user interface, however there is no dynamic usage of the user attributes in order to adapt the user interface, nor does it consider user interfacial behavior.

What is needed in the art is the disclosure of new systems and methods, which will adapt attributes of the user interface to the user's actual physical characteristics, interfacial behavior, as well as ambient conditions.

### SUMMARY OF THE INVENTION

The present invention provides new systems and methods that take into account multiple physical aspects of the user in order to better adapt the user interface to the user's needs.

The user interface should be adaptable to the user and the ambient conditions and not to the designer stereotype. Users with certain physical characteristics should enjoy an interface that is customized for them. Other users with different physical characteristics should get a system that will take advantages of their physical capabilities,

When a change in ambient condition occurs, the system will automatically adapt to the new condition, to minimize the inconvenience of the user. All those adaptations should be done as automatic as possible, and as quick as possible.

The present invention provides a method for enhancing user interfaces:

sensing at least one user data sample to obtain at least one user token, wherein the at least one user token comprises at least one user token parameter;

estimating at least one user characteristic based on the at least one user token to obtain at least one estimated user characteristic;

matching at least one user interface parameter associated with the at least one estimated user characteristic to obtain at least one user adaptation attribute; and

modifying at least one user interface attribute associated with the at least one user interface parameter according to the at least one adaptation attribute.

In one embodiment, the at least one user token comprises to at least one user physical token. In one embodiment, the at least one user token comprises to at least one user interfacial behavior token. In one embodiment, the at least one user token parameter comprises to at least one user finger token parameter.

In one embodiment, the at least one user finger token parameter comprises to at least one finger width. In one embodiment, the at least one user finger token parameter comprises to at least one finger angle of approach. In one embodiment, the at least one user token parameter comprises to at least one user voice sample parameter.

In one embodiment, the at least one user token parameter comprises to at least one user face image sample parameter. In one embodiment, the at least one user token is extracted by using at least one typing error rate evaluation. In one embodiment, the at least one user token is extracted by using at least one neighbor key error rate evaluation.

In one embodiment, the at least one user token is extracted by using at least one typing rate evaluation. In one embodiment, the at least one user token is extracted by using at least one zoom rate evaluation. In one embodiment, the at least one user token is extracted by using at least one scrolling rate evaluation.

In one embodiment, the at least one user token is extracted by using at least one user range evaluation. In one embodiment, the matching includes: providing a database of user profile records, wherein each user profile record independently includes at least one stored user characteristic; matching the at least one estimated user characteristic to the at least one stored user characteristic of the user profile; and modifying the at least one user interface user attribute associated with the user profile record, provided that if there is no matching of the at least one estimated user characteristic to the at least one stored user characteristic, then a new user profile is created.

In one embodiment, the at least one estimated user characteristic includes at least one left handed user, at least one user's finger characteristics, at least one user having myopia, or a combination thereof. In one embodiment, the at least one user interface parameter associated with the at least one estimated user characteristic includes at least one size and resolution of display element, at least one touch screen sensitivity, at least one screen layout, or a combination thereof.

In another aspect of the present invention a method is provided for enhancing a user interface. The method includes:

sensing at least one ambient feature associated with at least one user operating environment parameter to obtain at least one user token, wherein the at least one user token comprises to at least one user token parameter;

estimating at least one ambient characteristic based on at least one user token to provide at least one estimated ambient characteristic;

matching at least one user interface parameter associated with the at least one estimated ambient characteristic to obtain at least one adaptation attribute; and

modifying at least one user interface attribute associated with the at least one user interface parameter according to the at least one adaptation attribute.

In an embodiment at least one user interface attribute associated with the at least one estimated ambient characteristic comprises at least one size and resolution of display element, at least one touch screen sensitivity, at least one screen layout, or a combination thereof.

In one embodiment at least one user interface attribute associated with the at least one estimated ambient characteristic is an audio output where said audio output is modified by an adaptation attribute in order to adapt it to one or more characteristics of a user; wherein said adaptation attribute can be selectable from the following list: audio volume increase, audio volume decrease, audio frequency increase, audio frequency decrease, audio replay in a faster pace, audio replay in a slower pace

In one embodiment of this aspect, the at least one user token is extracted by using ambient noise evaluation, ambient lighting level evaluation, or a combination thereof.

In another aspect of the present invention a method is provided for enhancing a user interface. The method includes:

sensing at least one ambient feature associated with at least one user operating environment to obtain at least one user token, wherein the at least one user token comprises to at least one user token parameter;

estimating at least one ambient characteristic based on at least one user token to provide at least one estimated ambient characteristic;

matching at least one user interface parameter associated with the at least one estimated ambient characteristic to obtain at least one adaptation attribute,

wherein the matching includes:
providing a database of user profile records, wherein each user profile record independently includes at least one stored user characteristic;
matching the at least one estimated user characteristic to the at least one stored user characteristic of the user profile; and
modifying the at least one user interface user attribute associated with the user profile record,
provided that if there is no matching of the at least one estimated user characteristic to the at least one stored user characteristic, then a new user profile is created; and

modifying at least one user interface attribute associated with the at least one user interface parameter according to the at least one adaptation attribute.

In another aspect of the present invention a system is provided for enhancing a user interface. The system comprising:

A sensor subsystem having at least one sensor, each said sensor provided with sensing capabilities for sensing at least one user data sample;

A processing apparatus in connection with said sensor subsystem, directed to:
(a) obtaining at least one user token, wherein the at least one user token comprising at least one user token parameter;
(b) estimating at least one user characteristic based on the at least one user token to obtain at least one estimated user characteristic;
(c) matching at least one user interface parameter associated with the at least one estimated user characteristic to obtain at least one user adaptation attribute; and
(d) modifying at least one user interface attribute associated with the at least one user interface parameter according to the at least one adaptation attribute.

In one embodiment the said sensor subsystem comprises at least one sensor from the following list: a camera touch screen, 3D camera, physical keyboard, microphone, range detector, accelerometer other motion detection device, game console sensor device.

In one embodiment the said processing apparatus comprises one or more CPU (Central Processing Unit) and/or GPU (Graphic Processing Unit).

In one embodiment the said processing apparatus comprises one or more CPU (Central Processing Unit) and/or GPU (Graphic Processing Unit).

In one embodiment said system contains at least one of: LCD display, TV Display, Mobile Device Display, Game console Display.

In one embodiment said system and said at least one user interface attribute associated with the at least one estimated user characteristic comprises at least one size and resolution of display element, at least one touch screen sensitivity, at least one screen layout, or a combination thereof.

In one embodiment said system contains at least a speakers, an earphones.

In one embodiment said system and said at least one user interface attribute associated with the at least one estimated user characteristic is an audio output where said audio output is modified by an adaptation attribute in order to adapt it to one or more characteristics of a user; wherein said adaptation attribute can be selectable from the following list: audio volume increase, audio volume decrease, audio frequency increase, audio frequency decrease, audio replay in a faster pace, audio replay in a slower pace.

In another aspect of the present invention a system is provided for enhancing a user interface. The system comprising:

A sensor subsystem having at least one sensor, each said sensor provided with sensing capabilities for sensing at least one ambient feature associated with at least one user operating environment parameter;

A processing apparatus in connection with said sensor subsystem, directed to:
(a) to obtain at least one user token, wherein the at least one user token comprises to at least one user token parameter;
(b) estimating at least one ambient characteristic based on at least one user token to provide at least one estimated ambient characteristic;
(c) matching at least one user interface parameter associated with the at least one estimated ambient characteristic to obtain at least one adaptation attribute; and
(d) modifying at least one user interface attribute associated with the at least one user interface parameter according to the at least one adaptation attribute.

In one embodiment said system and said at least one user interface attribute associated with the at least one estimated ambient characteristic comprises at least one size and resolution of display element, at least one touch screen sensitivity, at least one screen layout, or a combination thereof

In one embodiment said system contains at least a speakers, an earphones.

In one embodiment said system and said at least one user interface attribute associated with the at least one estimated ambient characteristic is an audio output where said audio output is modified by an adaptation attribute in order to adapt it to one or more characteristics of a user; wherein said adaptation attribute can be selectable from the following list: audio volume increase, audio volume decrease, audio frequency increase, audio frequency decrease, audio replay in a faster pace, audio replay in a slower pace.

The present invention is better understood upon consideration of the detailed description of the preferred embodiments below, in conjunction with the accompanying drawings.

### BRIEF DESCRIPTION OF THE DRAWINGS

Embodiments of the invention may be best understood by referring to the following description and accompanying drawings, which illustrate such embodiments. In the drawings:

FIG. 1A is a drawing illustrating how different finger sizes may hit different foot print areas over a touch screen x-y grid.

FIG. 1B is a drawing illustrating how different finger sizes may hit different foot print areas over a touch screen x-y grid.

FIG. 2A is a drawing illustrating the signature of a thin finger.

FIG. 2B is a drawing illustrating the signature of a thick finger.

FIG. 3A is a drawing illustrating the thin finger icon resolution over a touch screen x-y grid.

FIG. 3B is a drawing illustrating the thick finger icon resolution over a touch screen x-y grid.

FIG. 4 is a flow chart of the background art touch screen operation.

FIG. 5 is a flowchart describing an exemplary process of an adaptive resolution.

FIG. 6A is a schematic block diagram of an exemplary biometric based adaptive display interface.

FIG. 6B is a schematic block diagram of an exemplary biometric based adaptive display interface.

FIG. 6C is a schematic block diagram of an exemplary Interfacial Behavior-based adaptive display interface.

FIG. 6D is a schematic block diagram of an exemplary ambient sensing based adaptive display interface.

FIG. 7 is a schematic block diagram of an exemplary Data Collection Module.

FIG. 8 is a schematic block diagram of an exemplary Data Analysis Module.

FIG. 9 is a schematic block diagram of the operation of an exemplary State Control Sub-module.

FIGS. 10A and 10B provide a flowchart on the operation of the State Control Logic in an exemplary embodiment.

FIG. 11 is a block diagram of exemplary supporting system hardware.

The drawings are not necessarily to scale. Like numbers used in the figures refer to like components, steps, and the like. However, it will be understood that the use of a number to refer to a component in a given figure is not intended to limit the component in another figure labeled with the same number.

### DETAILED DESCRIPTION OF THE INVENTION

The present invention provides new systems and methods that take into account multiple physical aspects of the user in order to better adapt the user interface to the user's needs.

The following detailed description includes references to the accompanying drawings, which form a part of the detailed description. The drawings show, by way of illustration, specific embodiments in which the invention may be practiced. These embodiments, which are also referred to herein as “examples,” are described in enough detail to enable those skilled in the art to practice the invention. The embodiments may be combined, other embodiments may be utilized, or structural, and logical changes may be made without departing from the scope of the present invention. The following detailed description is, therefore, not to be taken in a limiting sense, and the scope of the present invention is defined by the appended claims and their equivalents.

Before the present invention is described in such detail, however, it is to be understood that this invention is not limited to particular variations set forth and may, of course, vary. Various changes may be made to the invention described and equivalents may be substituted without departing from the true spirit and scope of the invention. In addition, many modifications may be made to adapt a particular situation, material, composition of matter, process, process act(s) or step(s), to the objective(s), spirit or scope of the present invention. All such modifications are intended to be within the scope of the claims made herein.

Methods recited herein may be carried out in any order of the recited events, which is logically possible, as well as the recited order of events. Furthermore, where a range of values is provided, it is understood that every intervening value, between the upper and lower limit of that range and any other stated or intervening value in that stated range is encompassed within the invention. Also, it is contemplated that any optional feature of the inventive variations described may be set forth and claimed independently, or in combination with any one or more of the features described herein.

The referenced items are provided solely for their disclosure prior to the filing date of the present application. Nothing herein is to be construed as an admission that the present invention is not entitled to antedate such material by virtue of prior invention.

Unless otherwise, indicated, the words and phrases presented in this document have their ordinary meanings to one of skill in the art. Such ordinary meanings can be obtained by reference to their use in the art and by reference to general and scientific dictionaries, for example, Webster's Third New International Dictionary, Merriam-Webster Inc., Springfield, Mass., 1993 and The American Heritage Dictionary of the English Language, Houghton Mifflin, Boston Mass., 1981.

The following explanations of certain terms are meant to be illustrative rather than exhaustive. These terms have their ordinary meanings given by usage in the art and in addition include the following explanations.

As used herein, the term “about” refers to a variation of 10 percent of the value specified; for example about 50 percent carries a variation from 45 to 55 percent.

As used herein, the term “and/or” refers to any one of the items, any combination of the items, or all of the items with which this term is associated.

As used herein, the singular forms “a,” “an,” and “the” include plural reference unless the context clearly dictates otherwise. It is further noted that the claims may be drafted to exclude any optional element. As such, this statement is intended to serve as antecedent basis for use of such exclusive terminology as “solely,” “only,” and the like in connection with the recitation of claim elements, or use of a “negative” limitation.

As used herein, the term “characteristic” refers to trait, quality, or property or a combination thereof that distinguishes an individual, a group, or type. An example of a characteristic is a “left handed user.” This characteristic can be estimated by different tokens, for example, typing error rate, since left hand users may have higher error rate because the device display is set up for right-handed people.

As used herein, the terms “one embodiment,” “an embodiment” or “another embodiment,” etc. Mean that a particular feature, structure, or characteristic described in connection with the embodiment is included in at least one embodiment of the present invention. Thus, the appearances of the phrases “in one embodiment” or “in an embodiment” in various places throughout this specification are not necessarily all referring to the same embodiment. Furthermore, the particular features, structures, or characteristics may be combined in any suitable manner in one or more embodiments.

As used herein, the terms “include,” “for example,” “for example,” and the like are used illustratively and are not intended to limit the present invention.

As used herein, the terms “preferred” and “preferably” refer to embodiments of the invention that may afford certain benefits, under certain circumstances. However, other embodiments may also be preferred, under the same or other circumstances. Furthermore, the recitation of one or more preferred embodiments does not imply that other embodiments are not useful, and is not intended to exclude other embodiments from the scope of the invention.

As used herein, the term “token” is a measurement-based entity utilized to estimate a characteristic (e.g., a user's characteristic or an environment's characteristic). For example, a token of a user's finger width can be extracted based on capacitance array readings.

As used herein, the term “user group” refers to a plurality of users having one or more common attribute in which each attribute is defined by one or more parameters and each parameter independently has either a discrete or a continuous set of values.

As used herein, the term “user interface” refers to the interactions between human and machines

As used herein, the term “user token” is a measurement-based entity utilized to estimate a characteristic (e.g., a user's characteristic or an environment's characteristic).

In one embodiment, a user communicates with a computerized system via a touch screen. Non limiting examples of such computerized systems include laptops, personal computers, mobile phones, TV displays, Personal Digital Assistant (PDA)/hand held devices, tablet computers, vehicular mounted systems, electronic kiosks, gaming systems, medical care devices, tenant portal devices, instrumentation for people with special needs, simulators, defense system interfaces, electronic books, and the like.

A touch screen display utilizes at least one well-known technique for sensing a pointing element. A pointing element may comprise a user finger (in some cases more than one finger) or a stylus. The touch screen sensor apparatus is designed to sense and deduce the location of the pointing element over the screen and optionally its distance and a measure of pressure of the pointing element on the screen.

A common touch screen sensor apparatus may use one of several techniques well known in the art, including, for example, resistive touch panels, capacitance touch panels (self or mutual capacitance), infrared, optical imaging, dispersive signal technology, acoustic pulse recognition, and the like.

Referring to an example of a capacitance-based touch panel, the touch panel may be schematically viewed as a two dimensional array or grid of X-Y points, where each point receives a signal, which is a function of the proximity of a touching object to the location of that point over the touch panel. Such apparatus is disclosed in, for example, U.S. Pat. No. 4,639,720.

One embodiment relates to the usage of touch screens in computer screens and hand-held display devices. The finger pattern of the current user can be sensed and analyzed, for example, for the effective finger contact area (FCA). Following this analysis, human interface parameters are being adaptively set in an automatic or semi-automatic manner. Human interface parameters being adaptively set include, for example, icon size, keypad key size, location of the feedback (echo), portrait or landscape display, and the size and appearance of command keys on the screen.

In another embodiment, a camera is used to sense the distance, the angle of the user face or eyes relative to the display device, or a combination thereof. If the distance falls beneath a given threshold, it is assumed that either the object's size on the screen is too small for the user or there are other conditions, which decrease the user's ability to seamlessly view and comprehend the objects on the display device. These other conditions may include, for example, glare, sunlight, or insufficient display contrast. Accordingly, adaptive means are taken automatically or semi-automatically to improve the display conditions for the users. Such adaptive means may include, for example, increase displayed object sizes (e.g., character font sizes, graphical icon sizes, etc.), changes of colors, appearance of displayed objects, and change of frequency and amplitude of light emission of display device light sources.

In yet another embodiment, user interfacial behavior is being analyzed for the purpose of providing adaptive and optimized user interface. Other parameters, for example, typing speed, typing error rate, function activation pattern, and functional error rate may be analyzed to build a profile of the current user. That profile pertains to the calculated level of physical capabilities and experience of the current user with regard to the specific device and may be influenced by conditions including, for example, user's background, age, health, physical characteristics and general aptitude. User Interface parameters are subsequently automatically or semi-automatically adapted to the user's profile. Changes in appearance of interface elements, such as icons, menus, and lists, etc., are non exclusive examples of such adaptation.

In yet another embodiment, one or more biometric sensing devices are used to acquire one or more biometric samples from the user. These biometric samples are subsequently extracted into biometric tokens that are analyzed for generating estimates of one or more user personal parameters, which belong to the user's profile. These user personal parameters are subsequently used for Human Interface Parameters (HIP), which may be adaptively set in automatic or semi-automatic manner. An example of such process is a microphone (biometric sensing device), which is used to acquire biometric samples from the user (user speech). Biometric tokens (e.g., voice pattern, voice pitch, and the like) are subsequently extracted and analyzed to generate an estimate on the user's age range, gender, geographical origin, ethnic origin, or a combination thereof. For example, the user's age range estimate is used to adaptively set the Human Interface Parameters. Other examples may include the usage of a camera for estimating user age, gender, geographical origin, or ethnic origin.

In yet another embodiment relating to mobile communication devices, it has been shown that some user groups are more focused on audio communication sessions (e.g., phone calls), while other user groups are more focused on text messaging or internet applications. As used herein, the term “user group” refers to a plurality of users having one or more common attribute in which each attribute is defined by one or more parameters and each parameter independently has either a discrete or a continuous set of values. Examples of user groups may include: “A North American man in the age range 30-60” or “A European woman in the age range 15-25.” In these examples, the attributes may include, for example, gender, origin, and age where some attributes may have a discrete set of values (e.g., man or woman), while other attributes may have a continuous range of values (e.g., age range 15-25). Using systems and methods depicted in the context of the current invention, for example, the analysis of human physical characteristics and interfacial behavior, it is possible to estimate the probability of a user to fit into one or more predefined user groups and adapt the user interface accordingly. For instance, the interface may provide a one-click interface for a mobile phone call and more indirect access to a gaming application, when a higher probability of the user belonging to the “A North American man in the age range 30-60” user group is perceived. On the other hand, perceiving a higher probability of the user to be part of “An European woman in the age range 15-25” user group may yield one-click access to European rock band clips and to Short Message Service (SMS) messaging.

For the purpose of understanding the teachings of embodiments, the reader should distinguish between tokens and characteristics. As used herein, the term “token” is a measurement-based entity utilized to estimate a characteristic (e.g., a user's characteristic or an environment's characteristic). For example, a token of a user's finger width can be extracted based on capacitance array readings. In addition, other token examples may include estimated finger contour, finger's angle of approach, finger pressure, etc. Alternatively, a user's finger characteristics may be estimated with different tokens, for example, typing error rate.

As used herein, the term “characteristic” refers to trait, quality, or property or a combination thereof that distinguishes an individual, a group, or type. An example of a characteristic is a “left handed user.” This characteristic can be estimated by different tokens, for example, typing error rate, since left hand users may have higher error rate because the device display is set up for right-handed people. However, left handed probability can also be based on tokens, for example, the measurement of the angle by which the finger approaches the key. It is possible to use more than one token for producing compound characteristics utilizing the Data Fusion Sub-module. In order to extract tokens, a set of sensor(s) may be employed for sensing external features, for example, a user's physical features.

Another aspect in the context of the current invention is applying User Interface adaptation processes to virtual camera and 3D motion detection and/or virtual world and games systems, for example, Nintendo's Wii™ and Microsoft's Kinect for Xbox 360™. Using the systems and methods disclosed herein, it is possible to better adapt the system user's interface behavior according to user's characteristics, for example, his identifiable physical attributes, user group membership, etc.

Embodiments of the current invention depict at least two operation modes, which can be enabled and disabled, including (1) a User Profiling Mode and (2) a User Group Mode.

If none of the above two modes is enabled, then there is no stored information, pertaining to above embodiments, for example, past users' records. The system, therefore, monitors user's human physical characteristics and/or interfacial behavior for generating adaptive Human Interface Parameters on the fly.

If the User Profiling Mode is enabled, the system monitors the user's human physical characteristics and/or interfacial behavior in given time intervals. If the system identifies substantial non-gradual changes in the monitored data, the system assumes a change in the identity of the user, a change in the operating or environmental conditions, or a combination thereof, and provides a different set of Human Interface Parameters.

Under the User Profiling Mode, the system also contains a known user profile or profiles and optionally, operating or environmental conditions. For example, the system may match the current user to a set of previously known user profile(s) using methods that are known in the art, for example, biometric template matching. If a proper match is identified with an adequate confidence level, then the system can use a stored set of Human Interface Parameters, which were already calculated for this specific user. The system may also match current operating or environmental conditions with previously stored operating or environmental conditions and apply the appropriate settings.

If the User Group mode is enabled, the system is provided with a set of prototype User Groups and monitors the user's activity and/or operating and environmental conditions. In this mode, the matching process in performed vis-à-vis a set of predefined user groups, wherein each group independently contains a set of defined parameters. Typically, User Group definitions are downloaded into the device from a remote server, while User Profiles are generated locally on the device.

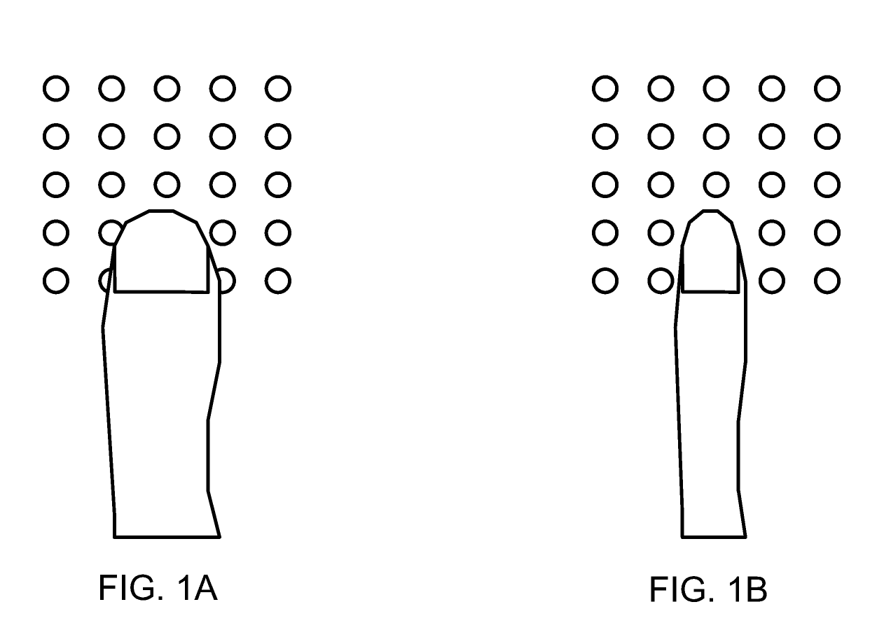

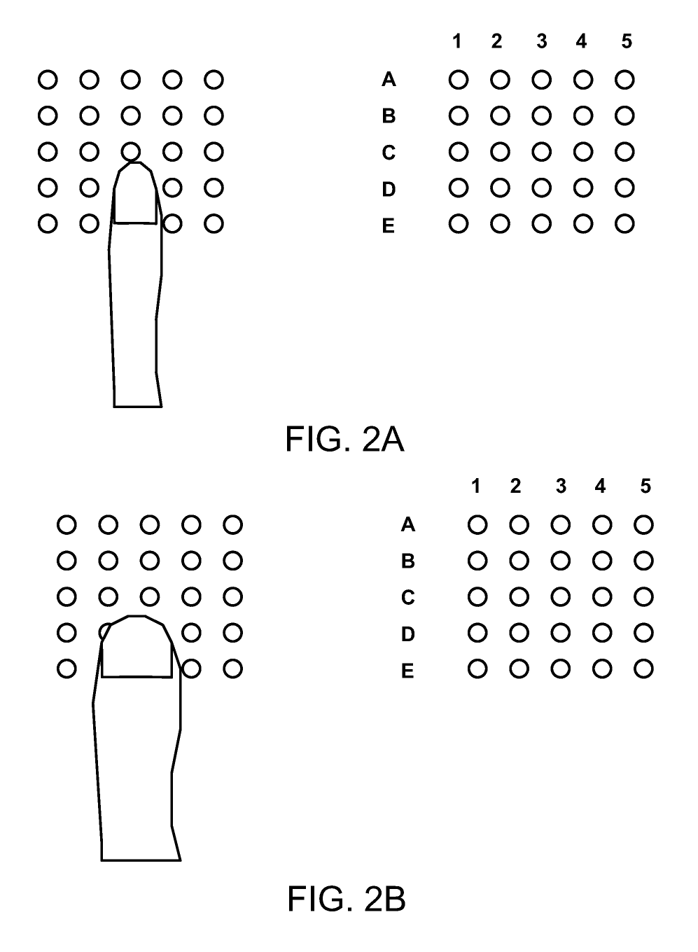

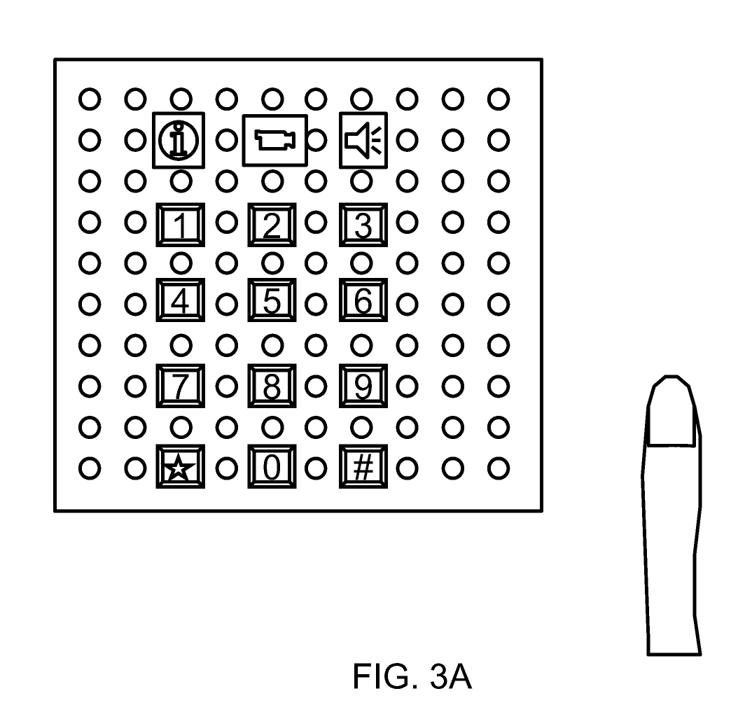

FIGS. 1A, 1B, 2A, and 2B depict how different finger sizes may hit different foot print areas over a touch screen X-Y grid. For given Xr-Yr resolution values, regardless of the specific touch screen implementation method, a “thin” finger may generate a concise and unambiguous location signature (see, e.g., FIG. 2A), while the exact locus of a “thick” finger cannot be determined of in the same level of resolution (see, e.g., FIG. 2B). As a result, the designer of the User Interface needs to either:

(a) provide a design, which is adapted to the users with a “thick” finger, allocate enough space per input element to accommodate different users, including those with, for example, thick finger size, by reducing the number of image icons or other display elements, which can be instantaneously displayed on the screen, and forcing unnecessary user scroll or flip page operations, or

(b) provide a design, which is adapted to “standard” or “thin” finger. In this case, a user with a “thick” finger would inevitably experience a much higher error rate while using the touch screen.

The designer may indeed provide a setup screen to the user. In the setup screen, the user may select his preferred key resolution. However, such explicit setup requirements have proved to be inconvenient and non-practical to most users, who prefer to use interfaces having minimal or no setup requirements.

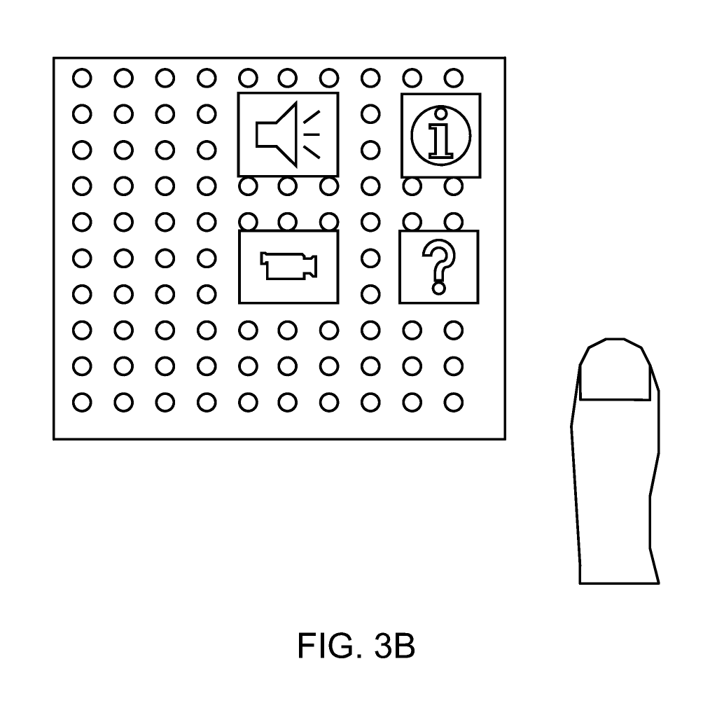

FIG. 3A and FIG. 3B show the number of surface grid points, which are triggered by using a “thin” finger and a “thick” finger, respectively. The number of grid points and the values induced in each grid point can be computed, and optionally averaged over time to estimate finger tokens. Tokens of the finger may herein include attributes, for example, dimensions, contour, area, etc. Finger tokens can also be applied to detect the use of a stylus pen (or other pointing device) instead of a finger. Hence, the term finger is not limited to a human finger.

In one embodiment, an application that uses a touch screen, such as a virtual keyboard, where there is a tradeoff between the size of the input keys and the layout of the screen is described. This is a non-limiting example, to only demonstrate an application directed by this invention.

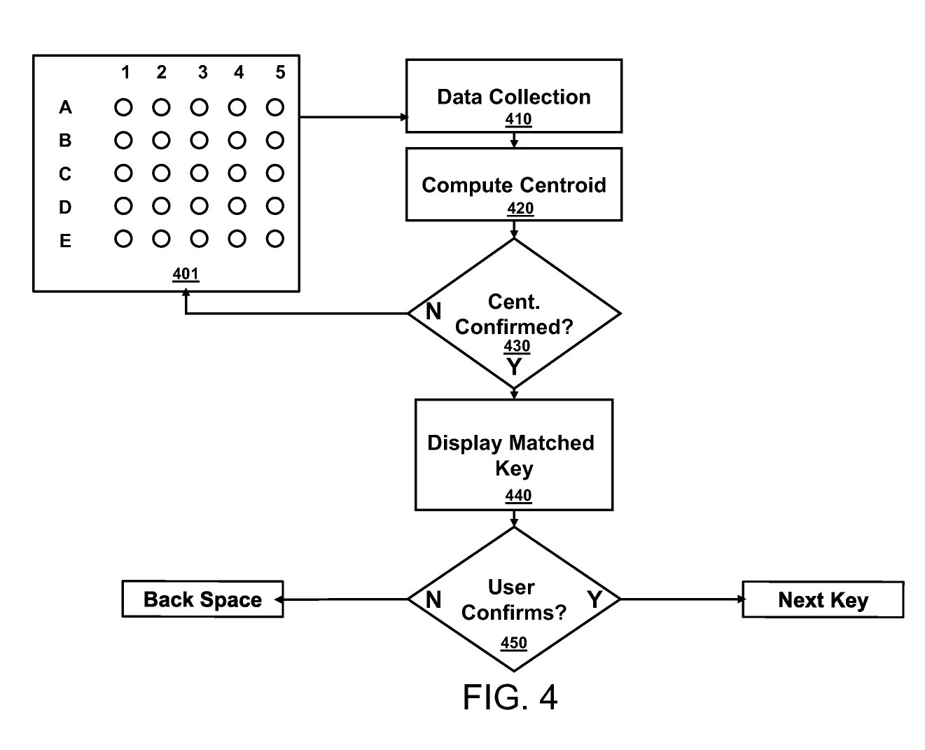

FIG. 4 is a flow chart of the background art application for this virtual keyboard usage. In step 410, data is collected for the X-Y grid points 401 that are in proximity to where the finger (or stylus pen) is touching the grid. A centroid of those grid points' locations is calculated in step 420. In step 430, an Xc-Yc position is to be confirmed. In order to be confirmed, the position should be generated with at least a predefined level of confidence and the application should find a matching key to this position.

If the position is confirmed, the key is displayed (step 440). Otherwise, the position is ignored and the flow returns back to step 410. The Xc-Yc position is sent to the application software that uses it to locate an input key, whose area contains that Xc-Yc position. The user may typically see the resulting key, and if needed, corrects it by pressing the backspace key and writing another key instead. In case the key is what the user intended to press, he or she can touch-type the next desired key. In any case, the process is repeated until the user chooses to conclude the virtual typing session.

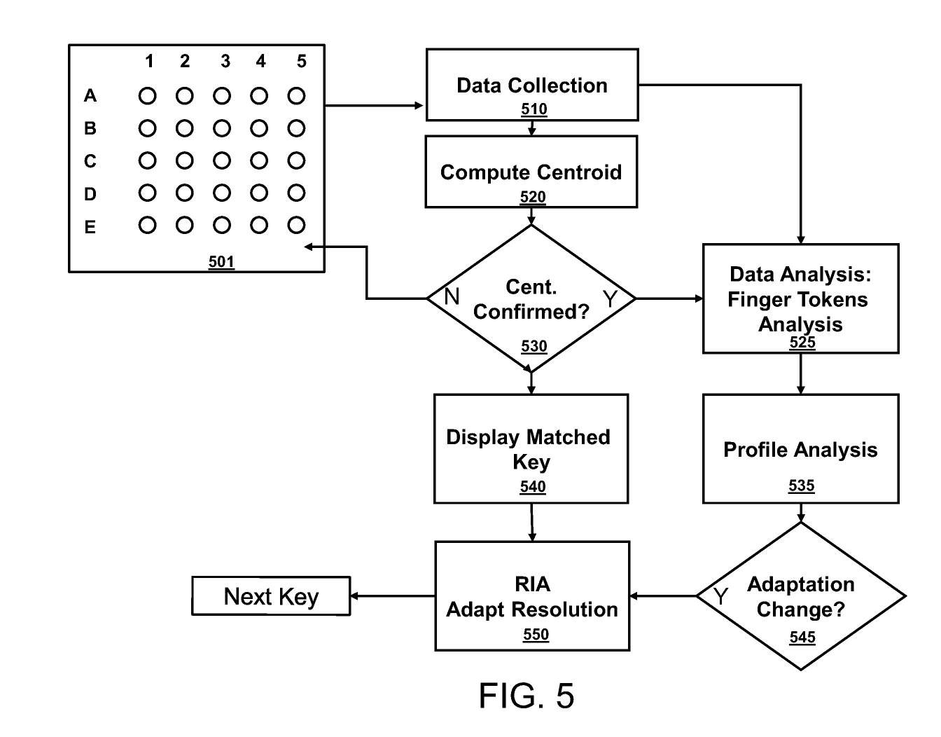

FIG. 5 is a flowchart that describes an exemplary process for adapting the layout size. The process begins by receiving the input from the touch screen array into Data Collection (step 510). The input Data Collection distributes the data to the common art operation path, which includes Centroid Calculation 520 and Confirmation 530 steps, similar to what is described above in FIG. 4.

In addition, the Data Collection distributes the input data for Data Analysis. If the centroid data is not confirmed in step 530, the data is ignored and the system waits for additional data from the touch screen array. If, on the other hand, the centroid is confirmed, the Data Analysis Module processes the input stream. The operation of these modules in some embodiments will be described below; but, as an illustrating example, the extracted tokens may include estimated width or other dimensions and contours of the user finger, which have been generated using the data from the latest touch screen event or events, which can be derived from the signal values and number of the points touched in the touch screen capacitive array.

The Data Analysis procedures may generate a compound set of characteristics based on the tokens. In step 535, the generated characteristics can be compared to known finger profiles (e.g., “thick” and “thin” finger models being the most simple cases), and the process also evaluates the adaptability attributes of the current display selection elements setting. If in step 545 it is determined that there is a need to better adapt display parameters to the user, the Resolution and Interface Adapter (RIA) Module communicates step 550 with the application or applications controlling the display in order to change display parameters. In this example, the relevant adaptation is to change the resolution of the display selection elements (e.g., graphic icons, virtual keys, etc.) to fit the finger size of the user, but other display parameters can be changed as well.

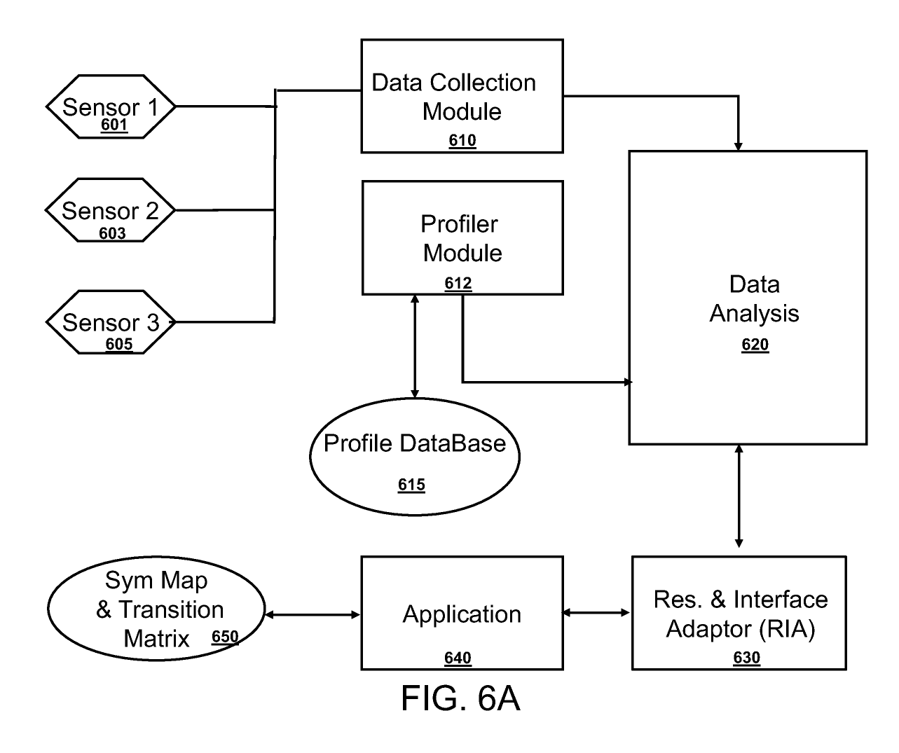

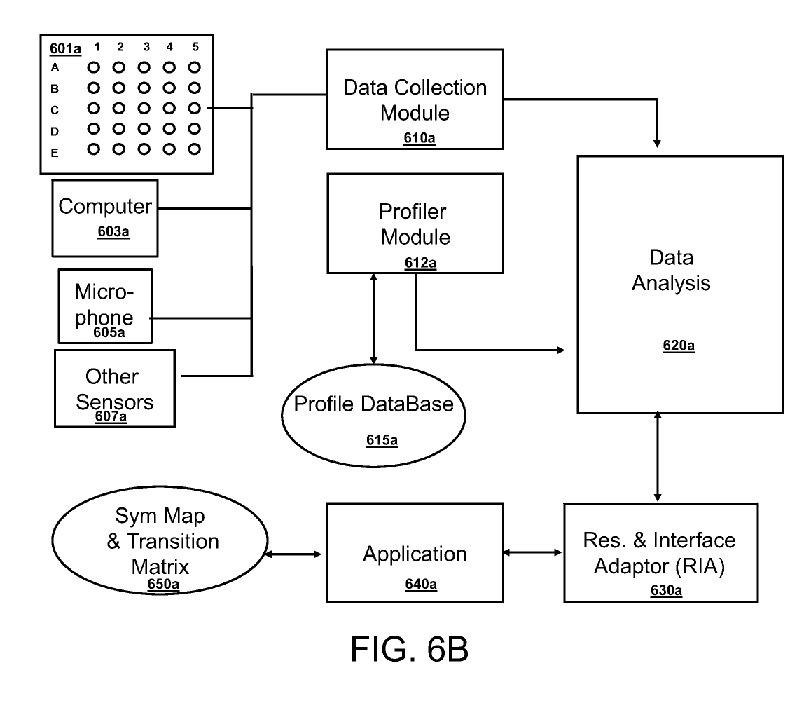

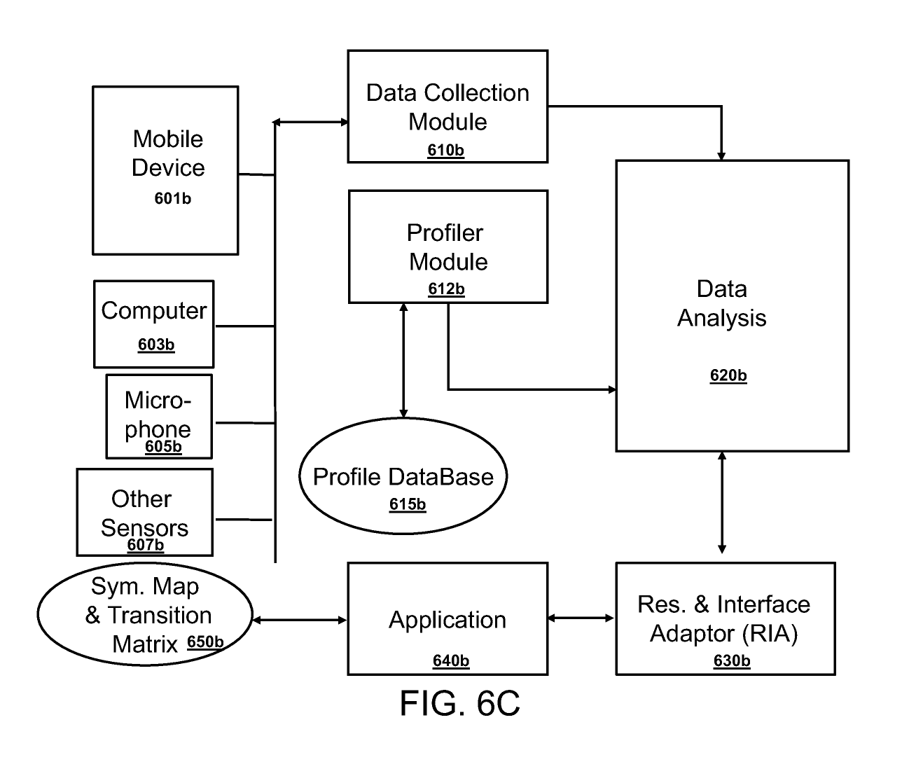

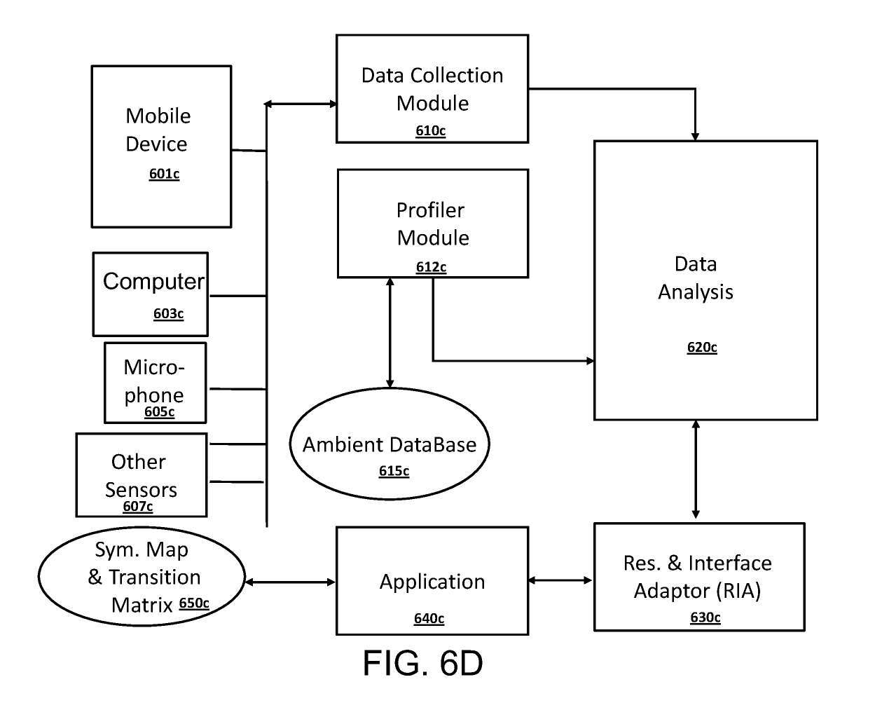

FIG. 6A discloses a schematic block diagram of an adaptive display interface pertaining to an embodiment of the current invention. One or more sensors (e.g., 601, 603, and 605) provide input data pertaining to the user and/or ambient conditions. These sensors may include, for example, a touch screen array as described herein, one or more cameras, one or more microphones, one or more range detectors, one or more 3D sensors, one or more motion sensors, one or more photometric devices, and a standard mechanical computer keyboard.

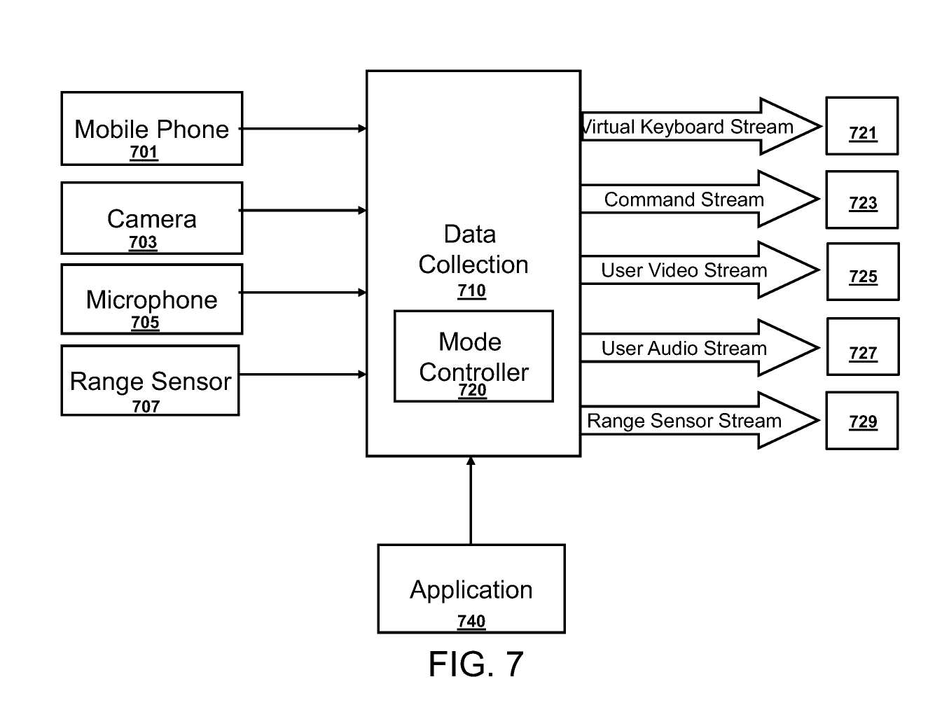

The Data Collection Module 610 collects the input data sources, and provides coherent data streams to the Data Analysis Module 620, as will be described in more detail in FIG. 7.

The Data Analysis Module 620 receives the data stream provided by the Data Collection Module 610. It first performs a validation, which is used to test the received data elements from each of the data streams whether they are valid, or may be part of an erroneous or a spurious signal. For example, data elements are checked if they are in the range of reasonable or acceptable limits (e.g., a finger size instance having a width parameter value of five centimeters, approximately two inches, is not valid).

After validation, the Data Analysis Module 620 extracts tokens out of the input data streams, and generates characteristics out of those tokens. The Data Analysis Module 620 also compares these tokens and/or characteristics versus a current user profile, other known users' profiles, user groups, or any combination of thereof, and ambient known conditions.

As part of the process, the Data Analysis Module 620 interfaces with the Profiler Module 612 to test whether the characteristics match the current user or a known set of users. Similarly, the Data Analysis Module 620 also compares ambient characteristics against known ambient characteristics stored at the Profiler. If needed, the Data Analysis Module 620 generates high level adaptation commands to the Resolution and Interface Adapter (RIA) Module 630. The structure and operation of the Data Analysis Module 620 in embodiments of this invention will be illustrated herein below.

The Resolution and Interface Adapter (RIA) Module 630 receives high level adaptation commands from the Data Analysis Module 620. It is in charge of applying the required adaptation changes to the user interface elements through interfacing with the Application program(s) 640 or directly via system drivers, which control the display and user input device.

It would be understood by a person with an average proficiency in the art that an application may share the display and input device(s) with other concurrently running applications, and therefore, the term Application may relate to a plurality of concurrently running applications. In such cases, the Resolution and Interface Adapter (RIA) Module 630 may interface with a plurality of applications at a given time period. Adaptation of a User Interface may include, for example, the following:

1. Change of size and resolution of display elements. Both display elements include display selection elements such as selection icons, menus, and keys in a virtual keyboard and display non-selection elements, which are “layout items.”

2. Change the screen layout from portrait to landscape (or vice versa).

3. Change brightness, contrast, color and/or appearance of display elements either as a result of changing ambient conditions or other reasons.

4. Touch screen sensitivity. Change the required pressure proximity or duration required for touch screen in order to trigger a “key pressed” identification.

5. Debouncing control. Change the parameters of key debouncing mechanism based, for example, on the user finger “pressure” measurement over (mechanical) keys or virtual keys of touch screen.

6. Change of Interface Language (either automatic or semi-automatic by querying the user).

7. 3D motion response, such as in a 3D motion tracking application (e.g., Wii™ or Kinect for Xbox 360™ game).

8. Adapt the User Interface to left handed users, when the analysis mechanism indicates this characteristic with high probability. For example, designing display layout so that display elements will not be occluded by the typing left hand.

Change voice and sound parameters, e.g., in the presence of increasing ambient noise level. For example, the interface may change the frequency response parameters for the sound generated by the device (such as changing the frequency pattern of the voices the user hears in a phone call), in order to provide better ability for the user to differentiate between ambient noise and signal voice. In such a case, a signal processing algorithm may optionally be provided which differentiates between at least one audio signal and at least one background noise (e.g. by frequency analysis, temporal signal analysis, direction, or combination of these methods). According to the differentiation, a signal processing function on the background noise (such as attenuation) and/or on the audio signal (e.g. changing its frequency response for better understanding according to user characteristics) may be applied. Other exemplary cases pertain to frequency reduction of voice for user with estimated older age.

Similarly, the audio volume may be increased or decreased. In loud ambient conditions, the audio volume will be increased, and conversely, when there is no ambient noise, the audio volume will be cut dramatically. Also, in case of Interactive Voice Response (IVR), or in case of text reading via voice, the pace of the voice replayed can be changed.

The Resolution and Interface Adapter (RIA) Module 630 can operate with or without the knowledge of each of the application(s). The application(s) often use a virtual screen layout (such as driver calls), while the physical layout is used by the Resolution and Interface Adapter (RIA) Module 630.

The Resolution and Interface Adapter (RIA) Module 630 also aggregates the power state, user presence and display capabilities of the device (as a whole or per the current Application). In case some adaptation attributes cannot be controlled due to display capability limitation or power states (as non-limiting examples), there may be no point for the Data Analysis Module 620 to process the pertaining tokens, and therefore, needlessly to consume CPU power and memory resources. In the same manner, there is no need for adaptations while the user is not present. Hence in such cases the Resolution and Interface Adapter (RIA) Module 630 notifies the Data Analysis Module 620, which notifies backward all the modules in the chain to temporarily reduce or suspend their operation.

Various variations of the embodiment depicted in FIG. 6A may be implemented. For example, FIGS. 6B, 6C and 6D illustrate 3 different modalities. The term modality in this text pertains herein to a set of characteristics, which have some common subject matter. While some exemplary embodiments are shown in the context of a certain modality (or set of modalities), the invention is neither limited to a certain modality nor to the set of described modalities and may be used in any partial or full combinations thereof. Each modality pertains to the nature of characteristics and tokens that are tracked and analyzed.

The first modality relates to biometric-based characteristics (FIG. 6B). Non-limiting examples of extracted tokens include user finger dimensions, user voice tokens (e.g., pitch, temporal and phonetic patterns), and user face image tokens. The tokens can be utilized to generate estimated characteristics such as user finger “thickness,” user age group, gender, ethnicity and mother tongue. These estimations can be based on the user's voice sample and/or face image and any other token, which relates to physical attributes and may influence adaptation decisions.

Examples of sensors for the embodiments presented in FIG. 6B are a Smartphone touch screen, a laptop camera, a microphone, or other sensors (correspondently shown as 601a, 603a, 605a, 607a).

Another modality shown in FIG. 6C pertains to user interfacial behavior characteristics. Extracted and analyzed set of tokens may include, for example, typing speed, typing error rate, function activation pattern, functional error rate and fingers approach angles. These tokens can be extracted from a virtual keyboard stream. In this case, one of the sensors is a Smartphone touch screen 601b, as an example, associated with a virtual keyboard application. While a similar set of sensors may be used, the estimated characteristics are of a different type than those described in the above text for FIG. 6B.

Similarly, the camera in this case 603b may also be used for extracting some different tokens, such as user presence and user distance from the screen (it is also possible to use a range detector for this purpose). A close eye range may suggest that the user has myopia or other vision problems and conditions that may call for increasing the size of display elements. A detected distance range larger than usual may suggest hyperopia. The confidence level for the hyperopia hypothesis may be increased by detection (e.g., through voice samples) that the user age is, for example, above 45. Hence, the multiple tokens logic may create more concrete results.

Similarly, in FIG. 6D, similar procedures and elements may be used to yield another modality of ambient conditions. Representative tokens may include, for example, lighting levels (e.g., to distinguish between ambient characteristics such as indoor and outdoor environments), background noise conditions, and direct sunlight in the direction of the screen. The interface between the Data Analysis Module 620c and the Profiler Module 612c may achieve this result. In turn, the display may be adapted to give a clearer view per these conditions by changing color, brightness, contrast, and appearance of display elements. In the similar manner, the user interface may adapt its voice channels to noisy environments by changing the volume, replaying pace and frequencies of voice and sound signals.

FIG. 7 provides a schematic description of the Data Collection Module 710 in an exemplary embodiment pertaining to interfacial behavior modality. The Data Collection Module 710 receives input from at least one sensor and generates a set of coherent data streams for the Data Analysis Module (620). The generated streams may be a function of:

a) The given set of sensors (e.g., 701, 703, 705, 707);

b) The set of defined tokens;

c) The Application context;

d) Data slicing options as described some paragraphs below, or combinations thereof.

For example, if a defined token is a finger size, the Data Collection Module 710 will generate slices of data, each of which contains a set of touch screen array measurements, in many cases without relating to the active application.

If, on the other hand, expected tokens are typing rate and typing error rate, the Data Collection Module 710 will generate a stream of time stamped key representing numbers. Unlike the previous case, the Data Collection Module 710 should be aware of the application context (e.g., virtual keyboard) in order to correctly interpret its input.

The set of tokens to be extracted and Data Collection Mode Controller 720 define the way by which input from the Data Collection Module 710 is being sliced for analysis purposes. The following are examples of data slicing options:

(a) Raw Time Intervals—the time domain is divided into time intervals and data analysis is performed over the data in each interval. Averages, medians and other statistics are calculated per interval.

(b) Data Clustering—typically, when a user performs some function over the device, it is expected to have a large number of input operations (e.g., key strokes) in a relatively short time period, followed by periods of no input activity. Regarding the camera, there are periods of user presence versus non-presence. Regarding the microphone as a sensor, we can monitor user voice activity via the microphone or another connectivity device versus the lack of such voice activity. By using data clustering, one may distinguish between different user tasks and optionally between different users, thus providing a better adapted response to the user and its activities.

(c) User context recognition—to recognize and differentiate between distinct user tasks by analyzing user inputs, such as task delimiters (e.g., entering or exiting web application, Dial and Disconnect keys per a telephony session, the send button per an Short Message Service (SMS) or Multimedia Messaging Service (MMS) delivery and the like). Hence, by using user task recognition, one may distinguish between different user tasks and optionally between different users, thus providing a better adapted response to the user and its activities.

(d) Sliding Windows—The stream will pass through a low pass filter with either a fix or variable tale size.

Indications according to the data slicing options may be sent to the Data Analysis Module 620 either within the data streams or separately.

In order to receive application context parameters and user task information, the Data Collection Module 710 may interface with one or more of the Device Application(s) 740.

In addition, the Data Collection Module 710 may optionally perform filtering functions such as continuous low pass filters. In such a case, the stream will go through a continuous filter (e.g., linear-low pass, Finite Impulse Response (FIR), Infinite Response Impulse (IIR) Kalman filters, non-linear filters or any other well-known method could be used for that purpose either separately or in a combination) with a determined tail size. The filters will produce values to be used for the Data Analysis Module 620.

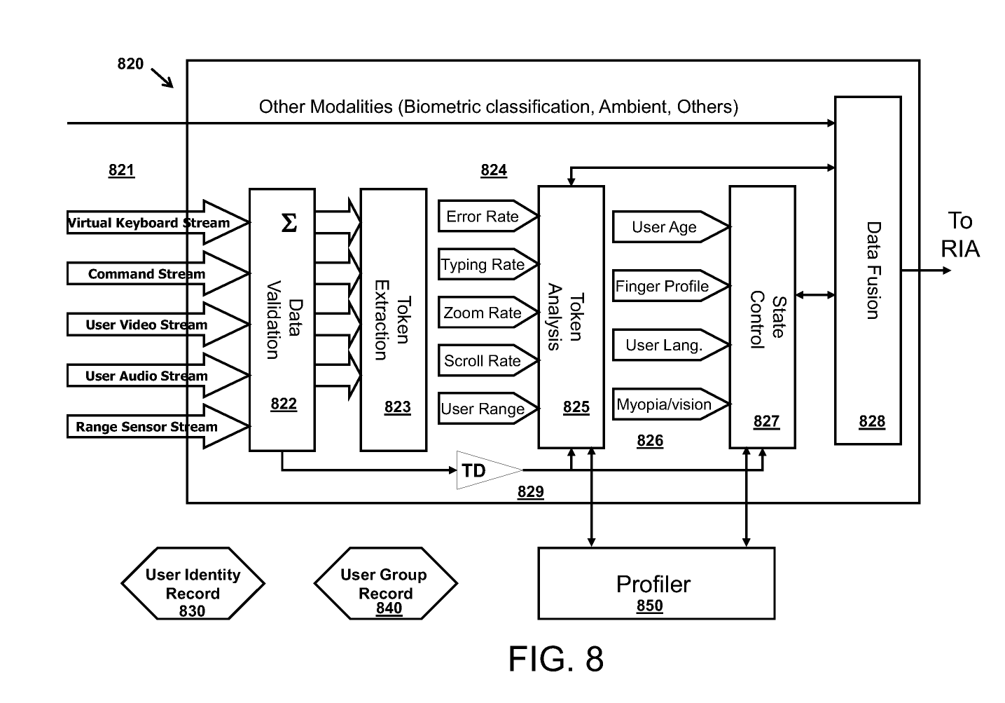

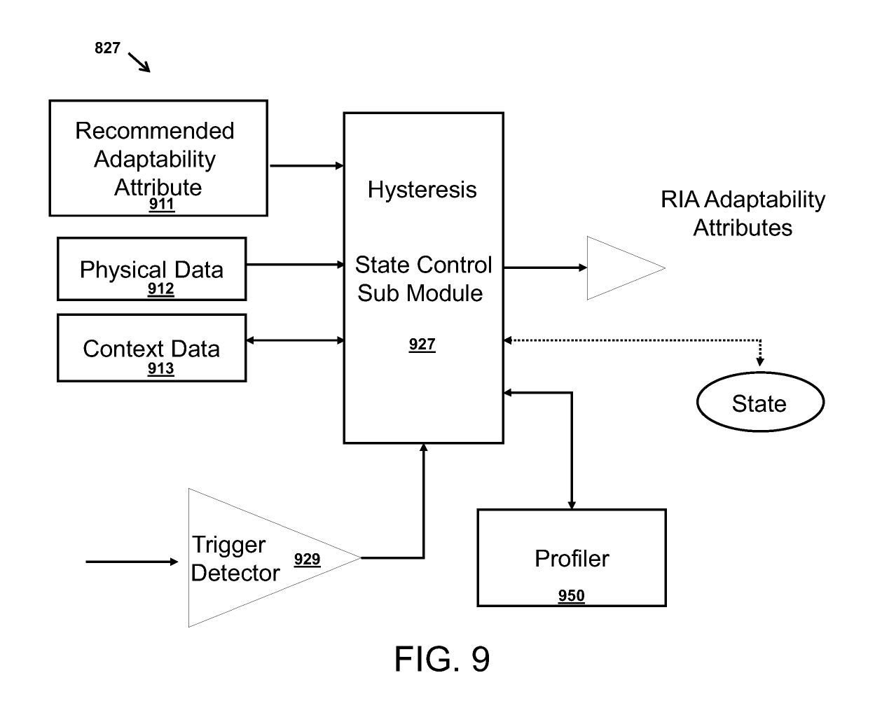

FIG. 8 provides a schematic description of the Data Analysis Module 820 in an exemplary embodiment pertaining to interfacial behavior modality.

For the purpose of increasing the clarity of the description, we now turn to describe without limitations some of the possibly extracted tokens (not all shown in FIG. 8):

Typing Error Rate—This token is extracted by compiling statistics from each time interval of errors that the user made while using virtual keys or other display selection elements. For example, errors may be calculated as the ratio between the backspace keystrokes and the total number of keystrokes (without counting backspace keystrokes). As an example, the user pressed in that time interval 11 keystrokes, 9 regular keys and 2 backspaces. Therefore, in this case, the typing error rate will be 22.2% (2/9). In another example, the typing error rate will be calculated as the number of times in which the user pressed a key representing “cancel” or “return to a previous screen” in relation to the total key activity.

Neighbor Key Error Rate—this token is similar to the previous one, but the goal here is to estimate the cases where the user hits a key (or another display selection element), which is adjacent to what he intended to, e.g., pressing “D” instead of “S” over a virtual keyboard. There are several ways to extract this token, as an example to count K1->C->K2 sequences, wherein K1 and K2 are adjacent display selection elements, and C is a display selection element representing a correction key such as “Back Space.”

Typing Rate—This token is extracted by compiling statistics of the total number of keystrokes (without backspace) or other display selection elements that the user pressed in a time interval, relative to a normal typing rate for the user and application.

Zoom Rate—This token is generated by computing the number of times the user conducted a zooming in/zooming out operation. Notice that there are several ways to conduct zoom in and zoom out. Without limitations, they include: pinch in pinch out, single tap, double tap and two fingers touch. Statistics on the zoom in activities as well as zoom out activities will be recorded in a time interval. In all cases, the zooming can be used either to widen the image fonts (widening operation) or to narrow the image fonts (narrowing operation). The Module calculates the amount of widening or narrowing that takes place in each time interval. For example, a result of the calculation can be that the user had widened the image fonts by 11% in each time interval.

An option for the Zoom Rate token, as well as all other tokens, is to get token values per application. A user may want, for example, to see and manage higher resolution in an email application (generating more zoom out operations), but in other applications he or she may need or prefer lower resolution (zoom out).

Scroll rate—this token is generated by computing the number of times the user pressed on any scrolling related key in each time interval. Scroll rate token value may represent an absolute or relative value.

User range—This token is extracted using camera/video and/or range sensor streams for computing the distance and also optionally the angle of the user face and/or eyes relative to the display device.

Some other modalities' tokens may include, for example:

Finger dimensions and contour size—This token can be extracted using touch screen array signals. Associated tokens may include finger angle and finger pressure based e.g., on touch screen capacitance array readings.

Voice sample based tokens such as pitch level, length of voice, phonemes analysis, etc.

Data streams 821 are received into the Data Validation Sub-module 822. The Data Validation Sub-module 822 may test the validity of each data stream based on well-known signal processing methods such as Signal to Noise Ratio (SNR) calculation. Additionally, it may check whether the data values are in the expected valid range. Further, it can check coherency of data between different streams. As an example, if the virtual keyboard stream indicates activity while the Range sensor stream does not detect any user presence, then at least one of these two streams is not valid.

Additional more high level data validation procedures may take place based on indications according to the data slicing options received from the Data Collection Module (710), such as device context, application/task context, etc. For example, the validity of user's audio stream may be reduced if the current active application is a non-voice application, or if the Data Analysis Module 820 receives a virtual key press while Application context indicates that the virtual keyboard is not active.

Data Validation results according to the data slicing options are forwarded to the Token Extraction Sub-module 823 as well as to the Trigger Detector (TD) Module 829. The role of the Trigger Detector (TD) Module 829 is to detect a transition of a user, application change, events such as the user starting to use the device, context switch, change in environmental conditions, and so forth.

The Token Extraction Sub-module 823 extracts tokens out of the validated data streams. Shown exemplary Tokens 824 were described above. As previously noted, these tokens are related to an exemplary embodiment. However, any set of tokens including additional tokens not described, can be used in partial or full combination.

The Token Analysis Sub-module 825 produces characteristics based on the set of tokens. It may generate at least one characteristic based on a compound set of tokens (using the Data Fusion Sub-module 828 described below). The characteristic can be, for example, a user characteristic and/or an ambient characteristic.

An example of an estimated characteristic from a multiple set of tokens is user vision where the system estimates the probability that the user suffers from e.g., Myopia. This probability ratio will rise when the user demonstrates a short distance from the display. Alternatively, a larger than usual distance can indicate hyperopia. In this case, we can also use voice sample-based tokens or face image based tokens to estimate the age of the user. Therefore, the Data Fusion Sub-module 828 uses the compound estimated probability that the user age is above 45, as an example, to increase hyperopia probability and vice versa.

In that respect, it should be noted that a characteristic may be based not only on sensor data and token extraction, but also on information explicitly provided by the user or a third party. Referring to the above example, user age can be provided directly by the user or, for example, a network operator (in case such information disclosure is not prohibited by privacy terms), and thus the compound hyperopia probability would be based on a combination of sensor and non-sensor originated information. Similarly, other characteristics can be based on any combination of sensor and non-sensor originated information.

Yet another example of a compound characteristic is the ambient characteristic of noise levels. We can compare two extracted tokens: estimated noise from a Smartphone built in microphone versus the user voice level during a voice conversation. Since users tend to raise their speech volume in the presence of noise, this event be detected through the earphone microphone.

The Token Analysis Sub-module 825 may also generate adaptability attributes for a plurality of user interface parameters such as those previously described in the text relating to FIG. 6A (Resolution and Interface Adapter (RIA) Module 630).

For generating the adaptability attribute(s), the Token Analysis Sub-module 825 may interface with the Profiler Module 850. The Profiler Module 850 may handle several databases relating to:

1) Current user parameters—information related to the current user, the application(s) the user is in, and updates at each time interval.

2) Table of all users' parameters—information related to all users who have access to the device. In particular, a User Identification Record (UIR) 830 provides data to facilitate quick identification of the user in a multi-user environment. The term “identification” in this specific context does not necessarily mean “absolute” identification of the user (i.e., name, ID, etc.) but more typically the ability to distinguish between one user and another.

3) Table of User Group prototypes—Optionally, a User Group Record (UGR) 840 describing a user group prototype, which may be used to match the current user to one or more User Groups. In particular, the User Group Record (UGR) 840 may contain a “standard” or “average” user group. Since most of User Interfaces designs are tuned to a “standard” user model, we can compare the current user to this group in order to test whether he is “above” or “below” the average in user characteristic parameters and adjust the corresponding adaptability attribute accordingly.

4) Current ambient parameters—information related to the current ambient parameters, and updated at each time interval.

5) Table of ambient parameters—Examples include indoor lighting or outdoor lighting. The database includes Ambient Description Records (ADR). The Ambient Description Records (ADR) records have one key describing the nature of the data, i.e., external lighting, background noise, etc. Another field in the Ambient Description Records (ADR) includes a value. For example, lighting may have a value of 60-190 that corresponds to indoor lighting, and 191-400 that corresponds to outdoor lighting. An external table describes the levels. Other fields include adaptation levels per those records. For example, if the ambient lighting is 370 (very strong outdoor lighting), the adaptation will call for high contrast fonts.

The Token Analysis Sub-module 825 in tandem with the Profiler Module 850 provides the above defined user identification capability to distinguish between different users using the same device over time.

Distinction between different users may be provided, for example, by any combination of methods according to the following non limiting list:

a) Analysis of human biometric (physical) features
a. Finger area analysis.
b. Face recognition of the user using a camera.
c. Speech analysis using a microphone or any other identification mean(s).

b) User providing identification, such as a user name.

c) Analysis of user interfacial behavior. For example: typing rate, typing error rate, zoom rate., scroll rate, finger size, camera and microphone functionalities—as described in the text pertaining to FIG. 7.

Having the capability to differentiate between different users enables the option of generating, storing, retrieving, using and modifying user profiles. Similarly, the Profiler Module 850 contains multiple records of prototype ambient conditions representing different lighting environments and different sound background levels.

The Data Fusion Sub-module 828 may work in a server conceptual model and provides data fusion services to other Sub-modules. These fusion services may take place on several levels:

a) By processing a plurality of tokens to calculate a compound characteristic.

b) By processing a plurality of tokens to directly calculate an adaptability attribute.

c) By processing a plurality of characteristics to calculate an adaptability attribute.

Data fusion algorithms may be based on one or more fusion methods, from a simple weighted linear combination of the input elements to a complicated nonlinear logic.

The State Control Sub-module 827 is described in more details in FIG. 9. The embodiment basically discloses two operation modes, which can be enabled and disabled:

1) User Profiling mode.

2) User Group mode.

If none of the mode flags are set, the State Control Sub-module 827 is operating with a designated stateless mode.

In this stateless mode, there is no stored profile information, and in each cycle the characteristics and adaptability attributes are computed without regard to any known profile.

If the User Profiling mode is enabled, the Profiler Module 850 continuously updates the current user profile. The newly calculated characteristics are checked against the current profile, and the system has the capability to distinguish between different users using the User Identity Records as described above.

If the User Group mode is enabled, the Profiler Module 850 uses prototype User Group records and the newly calculated characteristics are checked against the current loaded profile vis-à-vis the prototype User Group records. The system has the capability to match characteristics to user group profiles as described above.

A state record contains a state stack where each state record contains the context of the current state, which may include:

1) Current Active Profile (if User Profiling mode and/or User Group mode are set).

2) Application context.

3) Time and values of latest adaptation commands sent to the application or applications via Resolution and Interface Adapter (RIA).

4) Filters values.

5) Hysteresis control values.

6) Latest set of characteristics values.

The State stack structure enables the system to quickly retain a previous set up in cases such as a previous user that had left the device and later returns.

Non continuous changes are detected in characteristic values and adaptability attributes that are generated each time the State Control Sub-module 827 applies the state transition logic.

The state transition logic receives Trigger Detector 929 information. The Trigger Detector 929 operates on a lower data level and can detect signal changes over the raw data stream and validation information from the Data Validation Sub-module 822 (see, e.g., the corresponding description for FIG. 8). Trigger Detector 929 may also receive Data Clustering and/or User Task Recognition signals from the Data Collection Mode Controller 720 (see, e.g., FIG. 7).

The adaptability attributes generated by the Data Analysis Module 820 should not jitter. Ideally, only when a new user or a new application is entered, the adaptability attributes should change in a few steps till they converge. In order to achieve that, a hysteresis filter (or a similar other jitter prevention procedure) is used that takes into account the recommended adaptability attributes 911, the state 912 (i.e., the previous set of attributes) and the context data 913 (i.e., the user and the application).

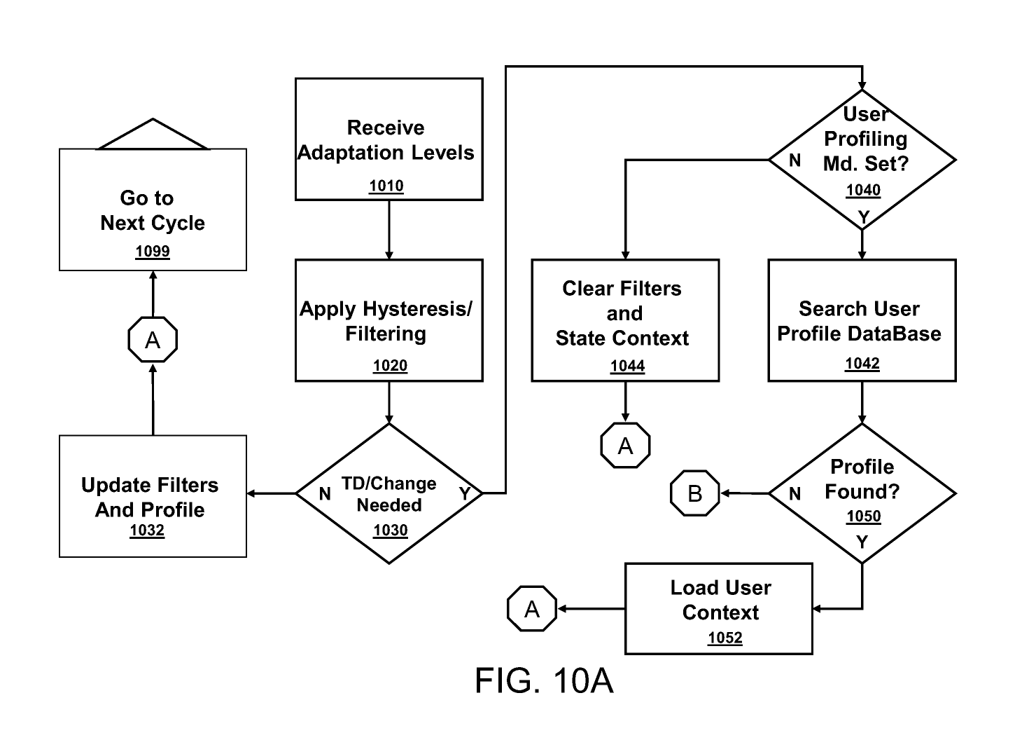

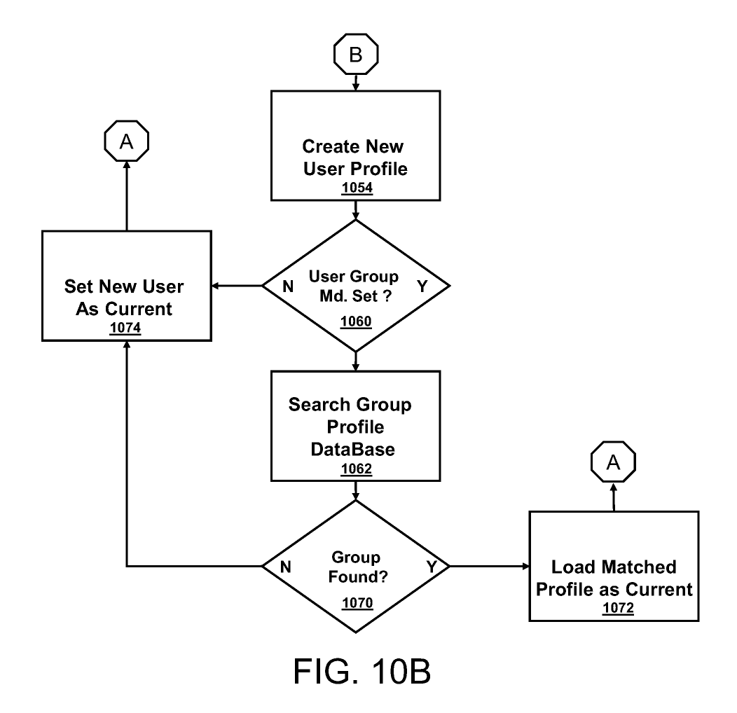

FIGS. 10A and 10B (FIG. 10B is a continuation of FIG. 10A illustrate a flow diagram of the State Control logic procedures operated by the State Control Sub-module in accordance with other elements in an exemplary embodiment.

In step 1010 (FIG. 10A), adaptation attributes of the current cycle are received. In step 1020, a state filtering technique such as a hysteresis filter is applied. The hysteresis filter is used to reduce the jitter that may be caused by the Resolution and Interface Adapter (RIA). In step 1030, a test for state change or Trigger Detection is done. If no trigger or state changes are detected then the user profile (in case User Profiling mode is enabled) is updated in step 1032. Next, the process proceeds to commence the next cycle of operation over the next predefined time interval (e.g., step 1099).

If, however, a state transition is detected, the flow proceeds to step 1040 where it tests if User Profiling mode is enabled. If this is not the case, any state context information is cleared (e.g., step 1044) and the flow is directed to the next cycle (e.g., step 1099).

If the User Profiling mode is enabled, the Profiler is used to search for another user matching the current characteristics and/or tokens (e.g., step 1042). In case such a user is found (e.g., step 1050), then his profile context is loaded from the Profiler Module 1052, with possible updates from the current cycle information and the process proceeds to the next cycle.

If, however, no user profile is found to match the current cycle parameters, a new user profile is created by the Profiler in step 1054 (see, e.g., FIG. 10B) based on the current cycle parameters. Then a test whether the User Group mode is enabled, follows in step 1060. If it is not, the new user is set as the current user (e.g., step 1064) and the flow moves to the next cycle (e.g., step 1099).

If the User Group mode is enabled, the Profiler searches its database for a user group matching the current cycle parameters 1062. If no match is found, the flow proceeds to step 1074, Otherwise, the group profile is loaded as the current user profile (possibly after an averaging process with the current parameters) and the flow again proceeds to the next cycle.

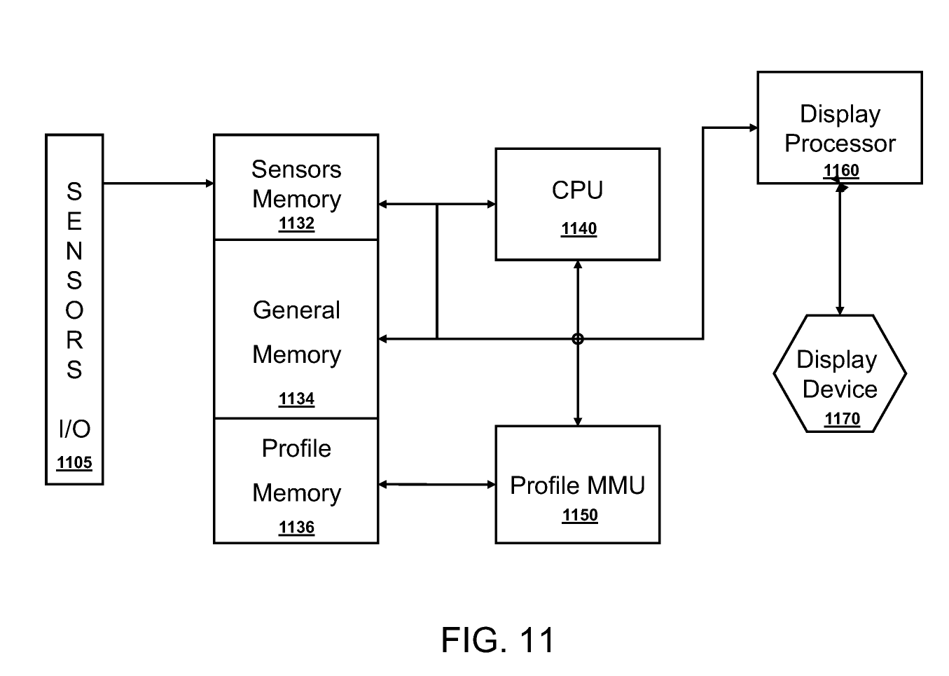

The current invention also discloses an article of manufacture utilized for implementing the above embodiments. FIG. 11 is a block diagram illustrating the supporting hardware implementation of the various modules in a preferred embodiment. The multiple modules described hereafter operate on a computer system with a central processing unit 1140, input and output (I/O) and sensor devices 1105, volatile and/or nonvolatile memory 1130, Display Processor 1160, Display Device 1170 and optionally a Profiler MMU (Memory Management Unit) 1150. The input and output (I/O) devices may include an Internet connection, a connection to various input and output (I/O) devices, and a connection to various input devices such as a touch screen, a microphone and a camera. The operational logic may be stored as instructions on a computer-readable medium such as a memory 1130, disk drive or data transmission medium. The optional Profiler MMU (Memory Management Unit) 1150 may be used to allow fast context switch between different profiles. In addition, part of the memory can be pre-allocated for fast sensor data processing.

The Display Processor 1160 preferably employs SIMD (Single Instruction Multiple Data) parallel processing scheme. Such scheme is implemented in processing devices known in the art as GPU (Graphic Processing Unit). In some cases, the Display Processor 1160 may perform computation tasks in addition to graphical display processing in order to share the load of executing the various tasks and procedures (including those described in this invention) with the central processing unit (CPU).

One skilled in the art will recognize that the particular arrangement and items shown are merely exemplary, and that many other arrangements may be contemplated without departing from the essential characteristics of the present invention. As will be understood by those familiar with the art, the invention may be embodied in other specific forms without departing from the spirit or essential characteristics thereof. The particular architectures depicted above are merely exemplary of an implementation of the present invention. The functional elements and method steps described above are provided as illustrative examples of one technique for implementing the invention; one skilled in the art will recognize that many other implementations are possible without departing from the present invention as recited in the claims. Likewise, the particular capitalization or naming of the modules, protocols, tokens, attributes, characteristics or any other aspect is not mandatory or significant, and the mechanisms that implement the invention or its features may have different names or formats. In addition, the present invention may be implemented as a method, a process, a user interface, and a computer program product comprising a computer-readable medium, system, apparatus, or any combination thereof. Accordingly, the disclosure of the present invention is intended to be illustrative, but not limiting, of the scope of the invention, which is set forth in the following claims.

In the claims provided herein, the steps specified to be taken in a claimed method or process may be carried out in any order without departing from the principles of the invention, except when a temporal or operational sequence is explicitly defined by claim language. Recitation in a claim to the effect that first a step is performed then several other steps are performed shall be taken to mean that the first step is performed before any of the other steps, but the other steps may be performed in any sequence unless a sequence is further specified within the other steps. For example, claim elements that recite “first A, then B, C, and D, and lastly E” shall be construed to mean step A must be first, step E must be last, but steps B, C, and D may be carried out in any sequence between steps A and E and the process of that sequence will still fall within the four corners of the claim.

Furthermore, in the claims provided herein, specified steps may be carried out concurrently unless explicit claim language requires that they be carried out separately or as parts of different processing operations. For example, a claimed step of doing X and a claimed step of doing Y may be conducted simultaneously within a single operation, and the resulting process will be covered by the claim. Thus, a step of doing X, a step of doing Y, and a step of doing Z may be conducted simultaneously within a single process step, or in two separate process steps, or in three separate process steps, and that process will still fall within the four corners of a claim that recites those three steps.

Similarly, except as explicitly required by claim language, a single substance or component may meet more than a single functional requirement, provided that the single substance fulfills the more than one functional requirement as specified by claim language.

All patents, patent applications, publications, scientific articles, web sites, and other documents and materials referenced or mentioned herein are indicative of the levels of skill of those skilled in the art to which the invention pertains, and each such referenced document and material is hereby incorporated by reference to the same extent as if it had been incorporated by reference in its entirety individually or set forth herein in its entirety. Additionally, all claims in this application, and all priority applications, including but not limited to original claims, are hereby incorporated in their entirety into, and form a part of, the written description of the invention. Applicants reserve the right to physically incorporate into this specification any and all materials and information from any such patents, applications, publications, scientific articles, web sites, electronically available information, and other referenced materials or documents. Applicants reserve the right to physically incorporate into any part of this document, including any part of the written description, the claims referred to above including but not limited to any original claims.

1. A method for enhancing a user interface comprising:
sensing at least one user data sample to obtain at least one user token, wherein the at least one user token comprises at least one user token parameter;
intermittently estimating at least one non-binary user characteristic value based on the at least one user token obtaining at least one user adaptation attribute, corresponding to at least one display selection element parameter associated with the at least one estimated non-binary user characteristic value; and
modifying at least one user interface attribute associated with the at least one said display selection element parameter according to the at least one said user adaptation attribute, such that the user interface attribute is adapted to fit the at least one estimated non-binary user characteristic value.

2. The method for enhancing a user interface of claim 1, wherein the at least one user token comprises, at least one user finger token parameter.

3. The method for enhancing a user interface of claim 2, wherein the at least one user finger token parameter is selectable from at least one finger width, at least one finger angle of approach.

4. The method for enhancing a user interface of claim 1, wherein the at least one user token parameter is selectable from at least one user face image sample parameter, and at least one user range evaluation parameter or a combination thereof.

5. The method for enhancing a user interface of claim 1, wherein the at least one user token is extracted by using at least one of: typing error rate evaluation, neighbor key error rate evaluation, typing rate evaluation., zoom rate evaluation, scrolling rate evaluation.

6. The method for enhancing a user interface of claim 1, wherein the matching comprises:
providing a database of user profile records, wherein each user profile record independently comprises at least one stored user characteristic value; matching the at least one estimated user characteristic value to the at least one stored user characteristic value of the user profile; and modifying the at least one user interface user attribute associated with the user profile record, provided that if there is no matching of the at least one estimated user characteristic value to the at least one stored user characteristic value, then a new user profile is created.

7. The method for enhancing a user interface of claim 1, wherein the at least one estimated user characteristic value comprises at least one left handed user, at least one user's finger characteristics, or a combination thereof.

8. The method for enhancing a user interface of claim 1, wherein at least one said user interface attribute associated with the at least one said display selection element parameter comprises at least one size and resolution of display selection element, at least one touch screen sensitivity, at least one display selection element layout, or a combination thereof, wherein said display selection element parameter can be set independently of at least one display non selection element parameter; and wherein user adaptation attribute further corresponding to at least the tradeoff between one display selection element parameter and at least one display non-selection element.

9. (canceled)

10. A method for enhancing a user interface comprising:
sensing at least one ambient feature associated with at least one user operating environment to obtain at least one ambient token, wherein the at least one ambient token comprises at least one ambient token parameter;
estimating at least one ambient characteristic based on at least one ambient token to provide at least one estimated ambient characteristic;
sensing at least one user data sample to obtain at least one user token, wherein the at least one user token comprises at least one user token parameter;
intermittently estimating at least one non-binary user characteristic value based on the at least one user token
matching at least one user interface parameter associated with the at least one estimated ambient characteristic and at least one user characteristic to obtain at least one adaptation attribute; and
modifying at least one user interface attribute associated with the at least one user interface parameter according to the at least one adaptation attribute.

11. The method for enhancing a user interface of claim 10, wherein the at least one user interface parameter associated with the at least one estimated ambient characteristic and at least one user characteristic comprises at least one size and resolution of display element, at least one touch screen sensitivity, at least one screen layout, or a combination thereof.

12. The method for enhancing a user interface as in claim 10 wherein the at least one user interface parameter associated with the at least one estimated ambient characteristic and at least one user characteristic comprises at least audio output, said audio output is modified by an adaptation attribute in order to adapt it to a one or more estimated ambient characteristics; wherein said adaptation attribute can be selectable from the following list: audio volume increase, audio volume decrease, audio frequency increase, audio frequency decrease, audio replay in a faster pace, audio replay in a slower pace.

13. A system for collecting and analyzing data for an adaptive user interface. The system comprising:
A sensor subsystem having at least one sensor, each said sensor provided with sensing capabilities for sensing at least one user data sample;
A processing apparatus in connection with said sensor subsystem, directed to:
(a) obtaining at least one user token, wherein the at least one user token comprising at least one user token parameter;
(b) intermittently estimating at least one non-binary user characteristic value based on the at least one user token;
(c) obtaining at least one user adaptation attribute corresponding to at least one estimated non-binary user characteristic; and
(d) modifying at least one user interface attribute associated with the at least one display selection element parameter according to the at least one said user adaptation attribute, such that the user interface attribute is adapted to fit the at least one estimated non-binary user characteristic value.

14. The system as in claim 13 where the said sensor subsystem comprises at least one sensor from the following list: a camera touch screen, 3D camera, physical keyboard, range detector, other motion detection device, and game console sensor device.

15. The system for enhancing a user interface of claim 13, wherein the at least one user token is a user finger token parameter.

16. The system for enhancing a user interface of claim 15, wherein the at least one user finger token parameter is selectable from at least one finger width, at least one finger angle of approach.

17. The system for enhancing a user interface of claim 13, wherein the at least one user token parameter is selectable from at least one user face image sample parameter, and at least one user range evaluation parameter or a combination thereof.

18. The system for enhancing a user interface of claim 13, wherein the at least one user token is extracted by using at least one of: typing error rate evaluation, neighbor key error rate evaluation, typing rate evaluation, zoom rate evaluation, scrolling rate evaluation.

19. The system as in claim 13 wherein at least one user interface attribute associated with the at least one display selection element parameter according to the at least one said user adaptation attribute comprises at least one size and resolution of display element, at least one touch screen sensitivity, at least one screen layout, or a combination thereof.

20. (canceled)

21. The method for enhancing a user interface of claim 1, wherein the at least one user token parameter is selectable from at least one user voice sample parameter, at least one user physical token parameter, at least one user interfacial token parameter or a combination thereof.

22. The method for enhancing a user interface of claim 1, wherein the at least said one user adaptation attribute corresponding to at least one display selection element parameter, further corresponds to at least one display non selection element parameter; and
wherein said user adaptation attribute is not equal to the adaptation attribute for at least one said display non selection element parameter.
